(19) United States
(12) Patent Application Publication
(10) Pub. No.: US 2026/0230138 A1
(43) Pub. Date: Aug. 6, 2026

(54) TECHNIQUES FOR REPORTING CHANNEL STATE INFORMATION DURING HANDOVER

(71) Applicant: QUALCOMM Incorporated, San Diego, CA (US)

(72) Inventors: Changhwan PARK, San Diego, CA (US); Jae Ho RYU, San Diego, CA (US); Lei XIAO, San Jose, CA (US)

(21) Appl. No.: 19/046,131

(22) Filed: Feb. 5, 2025

(51) Int. Cl. H04B 7/06; H04W 36/00; H04W 74/0833

(52) U.S. Cl. CPC H04B 7/0626; H04W 36/0058; H04W 74/0833

(57) ABSTRACT

Certain aspects of the present disclosure provide techniques for wireless communications. An example method includes receiving a configuration of a plurality of channel state information (CSI) reports; receiving an aperiodic CSI request that triggers transmission of CSI reporting, wherein the aperiodic CSI request indicates fewer CSI reports than the plurality of CSI reports; and transmitting the one or more CSI reports according to a rule that indicates a set of CSI reports, of the plurality of CSI reports, that are to be transmitted as the one or more CSI reports.

### INTRODUCTION

### Field of the Disclosure

Aspects of the present disclosure relate to wireless communications, and more particularly, to techniques for reporting channel state information during handover.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes receiving a configuration of a plurality of channel state information (CSI) reports; receiving an aperiodic CSI request that triggers transmission of CSI reporting, wherein the aperiodic CSI request indicates fewer CSI reports than the plurality of CSI reports; and transmitting the one or more CSI reports according to a rule that indicates a set of CSI reports, of the plurality of CSI reports, that are to be transmitted as the one or more CSI reports.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 depicts an example of UE mobility in a wireless communications network.

FIG. 7 is a diagram illustrating an example of a configuration of a plurality of channel state information (CSI) reports.

FIG. 8 is a diagram illustrating an example of signaling associated with reporting CSI based on an aperiodic CSI request

FIG. 9 depicts a method for wireless communications.

FIG. 10 depicts aspects of an example communications device.

### DETAILED DESCRIPTION

Aspects of the present disclosure provide apparatuses, methods, processing systems, and computer-readable mediums for channel state information reporting with aperiodic triggering.

Channel state information (CSI) reporting enables a user equipment (UE) to provide feedback about radio channel conditions to the network, such as a gNB. This feedback assists the gNB in making informed decisions about scheduling, precoding, modulation and coding schemes, and other radio resource management functions. CSI reporting can be configured as periodic (occurring at regular intervals) or aperiodic (triggered by the network on demand).

CSI reporting is performed according to configuration information. The configuration information includes a number of different information elements (IEs). For example, the configuration information may configure one or more associated CSI report configurations (e.g., via an IE associatedReportConfigInfoList). An associated CSI report configuration is configured with an index. An associated CSI report configuration is mapped to one or more CSI report configurations (e.g., one or more instances of reportConfigID). A CSI report configuration is mapped to one or more CSI resource configurations (e.g., one or more instances of csi-resourceConfigID). A CSI resource configuration is mapped to one or more CSI resources (e.g., one or more instances of nzp-CSI-RS-ResourceId). Aperiodic CSI reporting can be triggered for one or more associated CSI report configurations, as described below.

A network may support mobility operations, such as handover, so that a serving cell of a UE can be transferred from a source network entity (e.g., gNB, cell) to a target network entity (e.g., gNB, cell). Traditionally, handover has been performed in a semi-static fashion, using radio resource control (RRC) signaling. However, RRC-based handover signaling introduces some latency in the handover and involves some amount of disruption of ongoing communications.

Lower-layer triggered mobility (LTM) has been proposed as a way to enable a serving cell change via lower-layer signaling, such as Layer 1 signaling (e.g., physical-layer such as downlink control information) or Layer 2 signaling (e.g., medium access control (MAC) layer such as a MAC control element (MAC-CE)). LTM reduces latency, overhead, and interruption time relative to higher-layer-configured handover, and better supports beam-level handover than higher-layer-configured handover.

To further improve the efficiency of LTM, it has been proposed to enable CSI to be provided earlier in the handover procedure than upon connection to a target cell, such as before an LTM cell switch is performed or during the LTM cell switch.

One mechanism for triggering early CSI provision in LTM is to trigger aperiodic CSI reporting (sometimes referred to as an aperiodic channel quality information (CQI) report). For example, the UE may receive DCI that includes a one-bit trigger to transmit an aperiodic CSI report on a physical uplink shared channel (PUSCH). However, triggering of aperiodic CSI using the one-bit trigger may not be supported in some wireless communication technologies such as New Radio. For example, the one-bit trigger may be disabled in a random access response (RAR) uplink grant. This may be because a UE can be configured with multiple associated CSI report configurations (leading to triggering of a plurality of CSI reports), or a single associated CSI report configuration can be mapped to multiple CSI report configurations, multiple CSI resource configurations, and/or multiple CSI resources (also leading to triggering of a plurality of CSI reports). A one-bit trigger, alone, may not provide sufficient information to distinguish which CSI report or set of CSI reports are to be triggered by the one-bit trigger. Without a mechanism (e.g., rule) to distinguish which CSI report(s) are triggered by DCI in a RAR, it may be difficult or impossible to implement early CSI feedback in the context of LTM using DCI in a RAR.

Aspects of the present disclosure relate generally to identifying a set of CSI reports from a plurality of CSI reports to transmit. For example, the plurality of CSI reports may be configured via multiple associated CSI report configurations, multiple CSI report configurations, multiple CSI resource configurations, multiple CSI resources, or a combination thereof. When an aperiodic CSI request indicates fewer CSI reports than the plurality of CSI reports (such as based on the aperiodic CSI request including a one-bit indication, or a multi-bit indication incapable of indicating all of the plurality of CSI reports), the UE may identify and transmit one or more CSI reports of the plurality of CSI reports.

In some aspects, the UE transmits the one or more CSI reports according to an ordering of indexes of a configuration of the plurality of CSI reports. For example, the indexes may be assigned to associated CSI report configurations, CSI report configurations, CSI resource configurations, or CSI resources. In some aspects, the UE may transmit a CSI report with a lowest index (e.g., a CSI report according to a configuration with a lowest index, such as an associated CSI report configuration or a CSI report configuration with a lowest index). In some aspects, if the aperiodic CSI request indicates multiple CSI reports (e.g., the aperiodic CSI request has an n-bit field to indicate the multiple CSI reports), the UE may transmit a set of CSI reports according to configurations with lowest indexes (e.g., 2″ CSI reports according to 2″ configurations having lowest indexes).

In some aspects, the UE transmits the one or more CSI reports according to a mapping indicated in the configuration. For example, a network entity may configure the UE with a mapping from one or more values of the aperiodic CSI request to one or more CSI reports. In such examples, if the UE receives an aperiodic CSI request, the UE may identify and transmit the one or more CSI reports according to the mapping. For example, the mapping may indicate that the one or more CSI reports are to be transmitted in connection with a one-bit trigger in the aperiodic CSI request. As another example, the mapping may indicate that a value of the aperiodic CSI request (having two or more bits) is mapped to the one or more CSI reports. Reporting according to the lowest index or lowest indexes may reduce configuration complexity and overhead, whereas configuring and reporting according to a mapping in the configuration may provide increased flexibility for CSI triggering.

Thus, aspects described herein a mechanism (e.g., rule) to distinguish which CSI report(s) are triggered by DCI in a RAR, thereby enabling implementation early CSI feedback in the context of LTM using DCI in a RAR.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

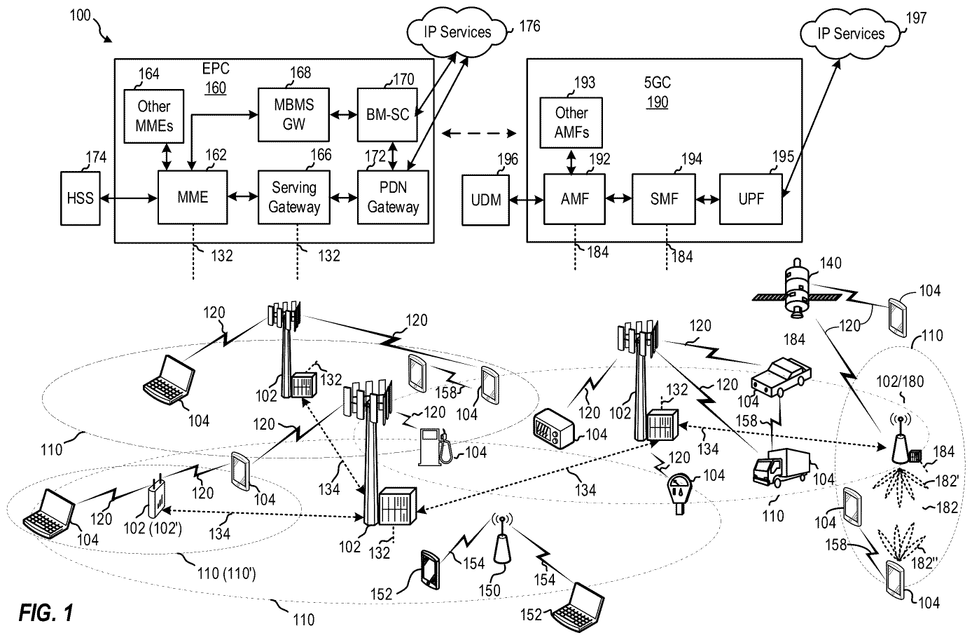

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

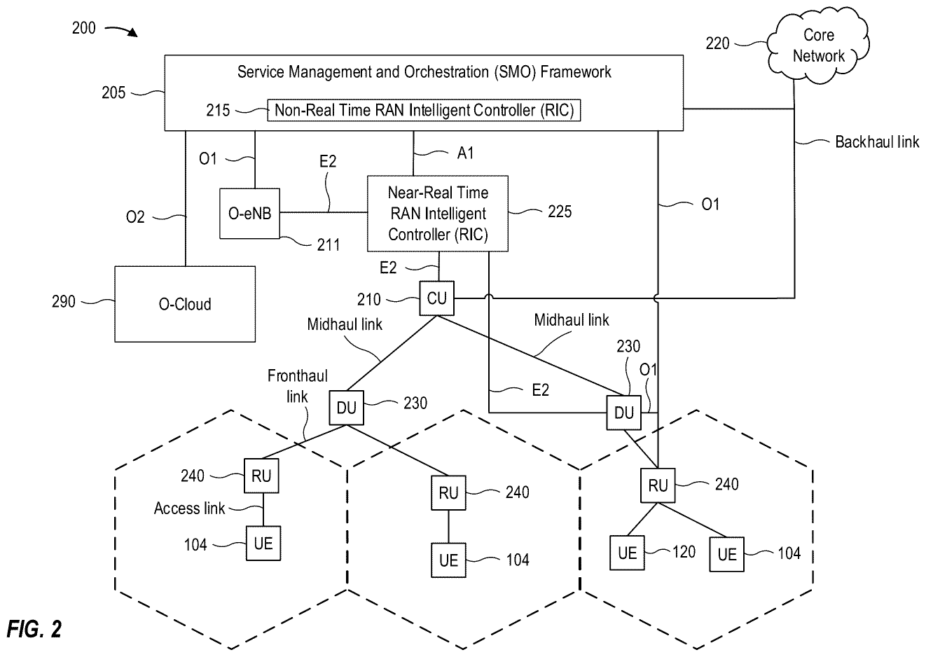

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

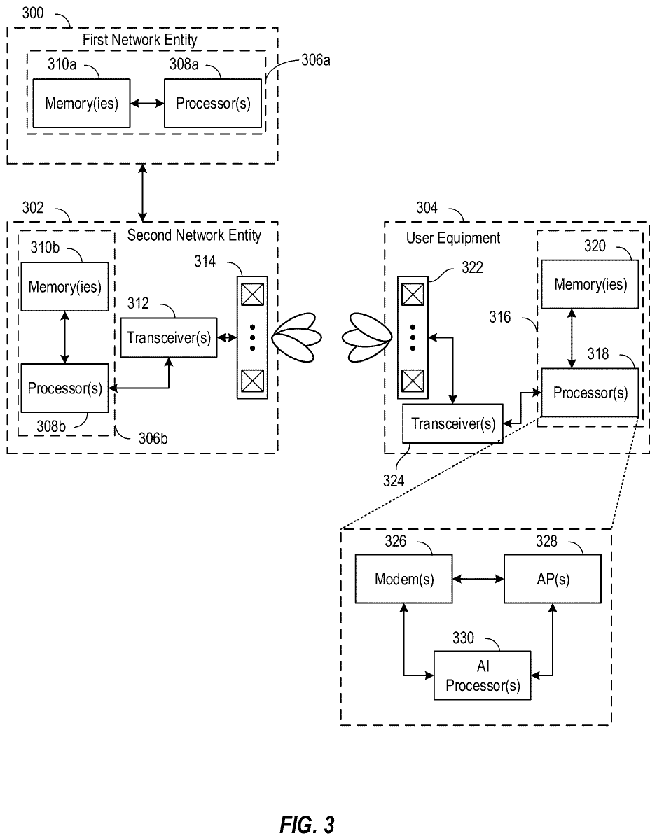

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory (ies) 310a” and “memory (ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

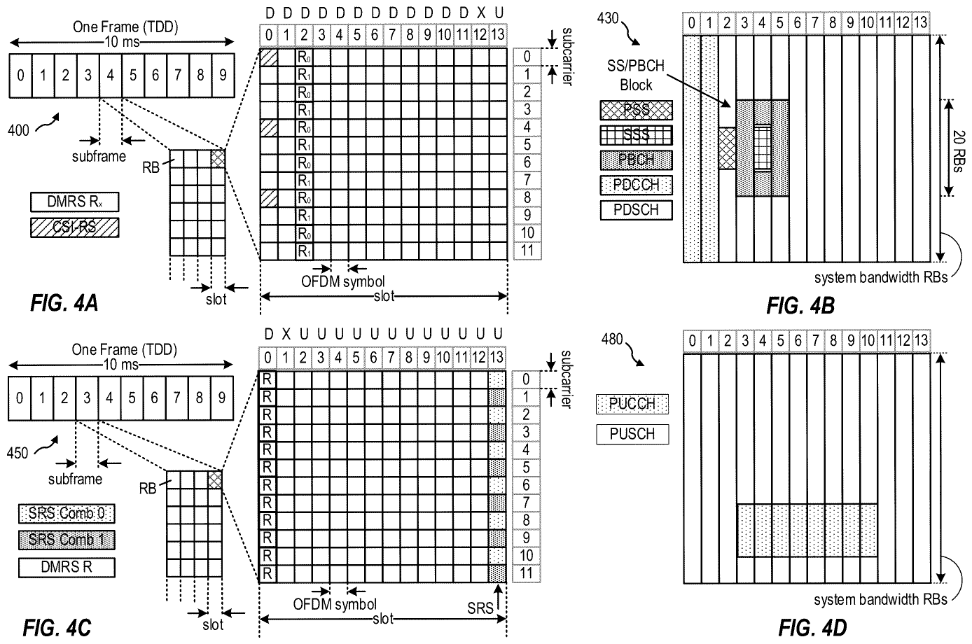

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ

ACK/NACK feedback. The PUSCH carries data, and may additionally be used to carry a buffer status report (BSR), a power headroom report (PHR), and/or UCI.

### Example Mobility Management

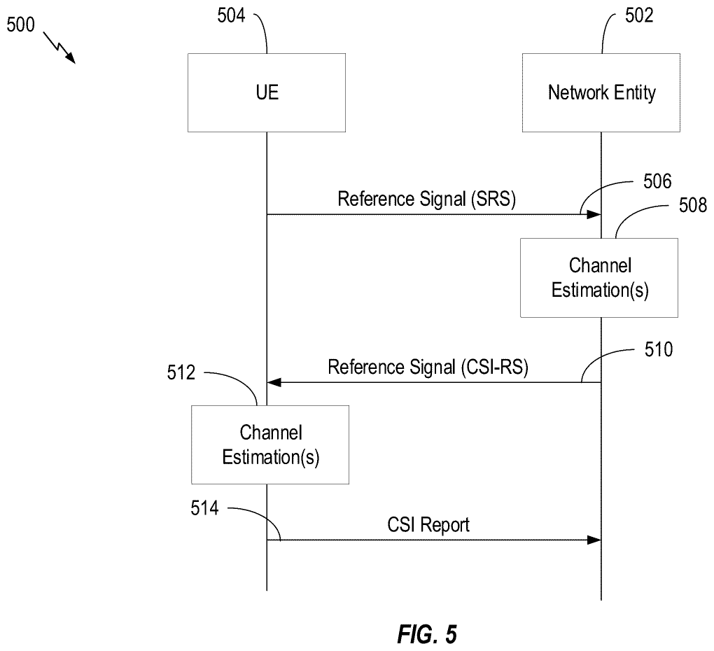

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In certain aspects, the UE 504 may send the reference signal (e.g. SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs channel calculations based on the reference signal, such as determining a channel estimate H based on the received reference signal, for example, as further described herein with respect to the UE performing channel calculations at 512. In certain aspects, the network entity 502 may further calculate, as part of the channel calculations, a precoder (e.g., precoder matrix) V based on the channel estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In certain aspects, the network entity may send the reference signal with precoding (e.g., beamforming, MIMO layer(s), and/or compensation for signal propagation effects) based on the channel estimate and/or precoder determined at 508.

At 512, the UE 504 performs channel calculations based on the reference signal, such as determining a channel estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector \vec{y} that is a representation of the received reference signal as received over each of the multiple antennas of the UE 504.

Based on a received signal model, the vector y can be represented as follows in equation (1):

$$\vec{y} = H \vec{x} + \vec{n} \qquad ( 1 )$$

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 502 over a number of spatial layers, and n is noise across the communications channel. In certain aspects, H has a size equal to the number of antennas used to receive the signaling, Nₐₙₜ, times the number of spatial layers, Nₗ, (e.g., the number of beamformed transmissions, number of antenna ports, etc.). For example, H has a number of rows equal to Nₐₙₜ and a number of columns equal to Nₗ. In certain aspects, the symbols that form the reference signal are known by the UE 504 (e.g., configured or preconfigured at the UE). UE 504 can determine the channel estimate H based on receiving the reference signal.

In certain aspects, UE 504 may further calculate, as part of the channel calculations, a precoder (e.g., precoder matrix) V based on the channel estimate H. For example, UE 504 may be configured to perform singular value decomposition (SVD) based precoding to determine the precoder V. For example, SVD(H)=[U S V], such that SVD provides the precoder V. U may be related to the ordering of the rows of H, as in the ordering of the antennas as represented by H. It should be understood that other suitable techniques may be used to determine the precoder V based on the channel estimate H.

At 514, UE 504 sends to the network entity 502 a CSI report indicating the determined channel estimate H and/or precoder V. For example, the UE may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using a modulation scheme, code rate, number of MIMO layers, or the like, that the network entity determines based on the CSI report.

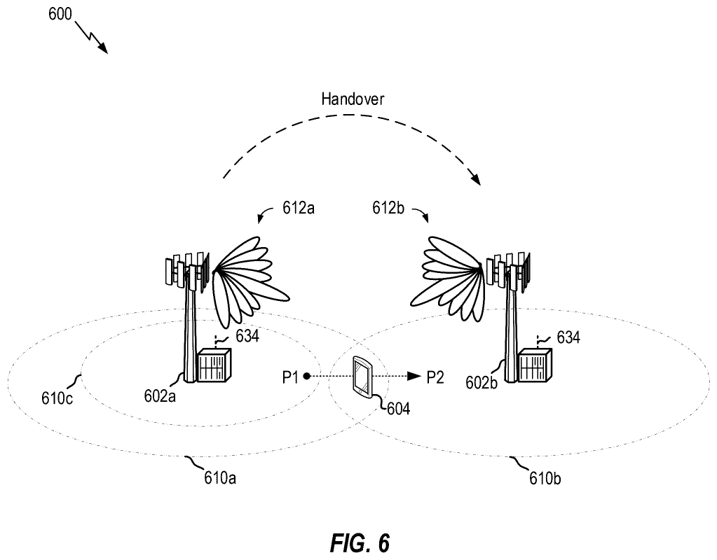

FIG. 6 depicts an example of UE mobility in a wireless communications network 600 (e.g., wireless communications network 100). In this example, the wireless communications network 600 may include a first network entity 602a having a first coverage area 610a and a second network entity 602b having a second coverage area 610b, which may overlap with the first coverage area 610a. The first network entity 602a may also have a third coverage area 610c. In certain aspects, the first coverage area 610a may form a first cell, the second coverage area 610b may form a second cell, and the third coverage area 610c may form a third cell. The first cell and third cell may form a first cell group, and the second cell may form a second cell group. The first network entity 602a may communicate via a first set of beams 612a, and the second network entity 602b may communicate via a second set of beams 612b.

Due to mobility (e.g., a UE 604 moving from the first coverage area 610a to the second coverage area 610b), the UE 604 may transition from communicating with the first network entity 602a via the first set of beams 612a to communicating with the second network entity 602b via the second set of beams 612b. As an example, the UE 604 may be located at a first position P1 in the first coverage area 610a and/or the third coverage area 610c at a first occasion, and then the UE 604 may move to a second position P2 in the second coverage area 610b at a second, later occasion.

In some cases, the UE 604 may send a measurement report to the first network entity 602a. For example, the first network entity 602a may configure the UE 604 to measure a set of neighboring cell(s) and/or beam(s) of one or more neighboring network entities (e.g., the second network entity 602b). In some cases, the UE 604 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 602a. As an example, the neighboring cell(s) and/or beam(s) may include the second cell of the second coverage area 610b and/or the second set of beams 612b. The measurement report may indicate radio measurements (e.g., signal strengths) associated with the serving cell of the first network entity 602a and/or neighboring cell(s), such as the cell(s) of the second network entity 602b. In certain cases, the measurement report may indicate the signal strengths associated with certain beam(s) of the serving cell and the neighboring cell(s), such as the first set of beams 612a and/or the second set of beams 612b. Based on the measurement report (e.g., indicating a stronger signal strength associated with radio measurements for the second network entity 602b relative to the first network entity 602a), the first network entity 602a may determine to handover (HO) communications with the UE 604 to the second network entity 602b. The first network entity 602a may be in communication with the second network entity 602b via a backhaul link 634 (e.g., an F1, Xn, and/or NG interface) in order to exchange information for the handover.

In the context of a handover or mobility operation, the first network entity 602a may be referred to as a source network entity; and the second network entity 602b may be referred to as a target, candidate, neighbor, or neighboring network entity, depending on the stage of the handover or mobility operation. As part of a handover, the source network entity transfers a connection with a UE to a target network entity. A candidate or neighboring network entity may be a possible target for the handover, and in some cases, the candidate or neighboring network entity may communicate via candidate cell(s) and/or beam(s) having coverage area(s) adjacent to or overlapping with the coverage area(s) of the source network entity.

In some cases, the handover may involve a CU/DU handover, such as inter-DU-intra-CU handover and/or inter-CU handover. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 602a and/or the second network entity 602b may be an example of an RU, DU, and/or CU.

Note that the handover illustrated in FIG. 6 is an example of a mobility operation. Aspects of the present disclosure described herein may be applied to various types of UE mobility operations including, for example, (conditional) lower-layer triggered mobility (LTM), L3 mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., certain QoS specification(s) for communications are satisfied).

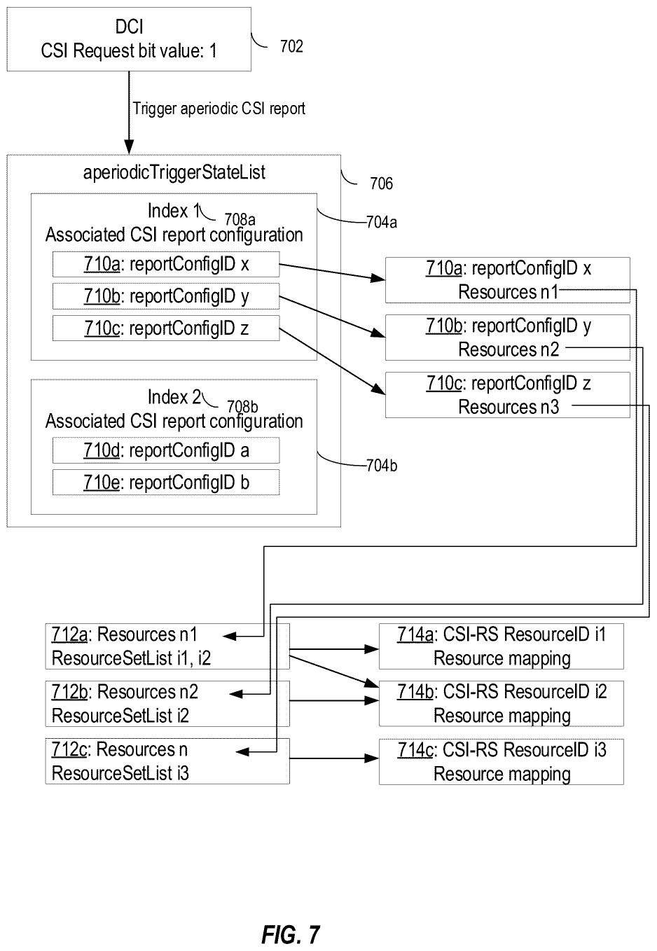

FIG. 7 is a diagram illustrating an example of a configuration 700 of a plurality of CSI reports. The configuration 700 may be configured via RRC signaling, such as via a set of RRC IEs. A UE (e.g., UE 104 or UE 304) may be triggered to transmit a CSI report by DCI 702. For example, the DCI 702 may be, be included in, or include a grant of a RAR. The DCI 702 may be considered or may include an aperiodic CSI request, which in FIG. 7, has a value of 1. This aperiodic CSI request may be referred to as a CQI request for an aperiodic CQI report on a PUSCH. Aspects described herein provide for resolution of ambiguity regarding which CSI report(s) should be triggered by the DCI 702, either based on ordering of indexes of the configuration 700 or a configured mapping.

The configuration 700 includes one or more associated CSI report configurations 704. For example, an aperiodic trigger state list 706 may include each of the one or more associated CSI report configurations 704. Each associated CSI report configuration 704 is associated with a respective index 708.

An associated CSI report configuration 704 is configured to refer to one or more CSI report configurations 710. Here, a reference to a CSI report configuration 710 is reference numbered in the same fashion as the CSI report configuration 710 itself. It should be understood that an associated CSI report configuration 704 includes a reference to a CSI report configuration 710, and may not explicitly include the CSI report configuration 710 itself. Each CSI report configuration 710 is associated with a respective identifier, which may be referred to herein as an index. For example, CSI report configuration 710a is associated with an identifier of “x.”

A CSI report configuration 710 (e.g., a reportConfigID, which may be configured as part of a csi-ReportConfigToAddModList parameter) is configured to refer to one or more CSI resource configurations 712. For example, a resourcesForChannelMeasurement IE of a CSI report configuration 710 may include an identifier (e.g., n1, in the case of CSI report configuration 710a) of a corresponding CSI resource configuration 712 (e.g., a csi-resourceConfigID IE).

A CSI resource configuration 712 is configured to refer to one or more CSI resources 714. For example, a CSI resource configuration 712 includes an IE csi-RS-ResourceSetList that includes indexes of the one or more CSI resources 714. For example, CSI resource configuration 712 includes indexes i1 and i2, corresponding to CSI resources 714a and 714b.

It can be seen that a single associated CSI report configuration 704 can refer to multiple CSI report configurations 710, where each CSI report configuration 710 defines a respective CSI report of a plurality of CSI reports. Furthermore, multiple associated CSI report configurations 704 can be configured. Thus, a configuration 700 may configure a plurality of CSI reports. Aspects described herein address ambiguity in which CSI report should be transmitted if the DCI 702 triggers fewer CSI reports than the plurality of CSI reports. For example, the DCI 702 may trigger fewer CSI reports than the plurality of CSI reports when the DCI 702 includes a one-bit indication as an aperiodic CSI request, since the one-bit indication alone does not provide sufficient information to identify a single CSI report from the plurality of CSI reports. As another example, the DCI 702 may trigger fewer CSI reports than the plurality of CSI reports when the DCI 702 includes a multi-bit field, but the multi-bit field includes an insufficient number of bits to indicate a single CSI report out of the plurality of CSI reports (e.g., a 3-bit field can only indicate 8 different values, which may be insufficient if 10 CSI reports are configured).

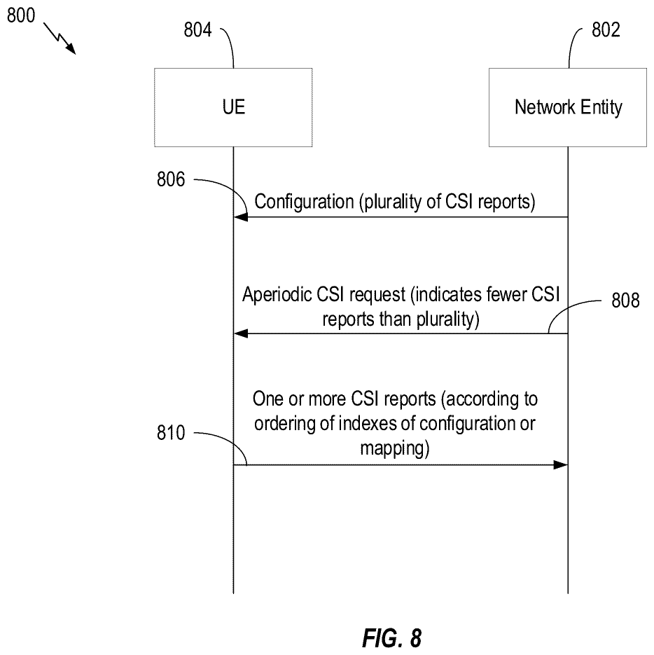

FIG. 8 is a diagram illustrating an example 800 of signaling associated with reporting CSI based on an aperiodic CSI request. Example 800 includes a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At 806, the network entity 802 may transmit, and the UE 804 may receive, a configuration 700. The configuration 700 may configure a plurality of CSI reports. For example, the configuration 700 may include a plurality of associated CSI report configurations 704 that are each mapped to a respective one or more CSI report configurations 710, such that in total there are a plurality of CSI report configurations 710 (corresponding to a plurality of CSI reports) configured for the UE 804. Additionally, or alternatively, the configuration 700 may include a single associated CSI report configuration 704 that is mapped to a plurality of CSI report configurations 710 (which correspond to a plurality of CSI reports). The UE 804 may receive the configuration 700 via RRC signaling or another form of signaling.

In some aspects, the configuration 700 (or other configuration signaling such as other RRC signaling) may indicate a mapping between an aperiodic CSI request and one or more CSI reports. For example, the configuration 700 may indicate a value of an aperiodic CSI request (e.g., a bit value or a multi-bit value) and one or more associated CSI report configurations 704 that are to be triggered by reception of an aperiodic CSI request including the value. As another example, the configuration 700 may indicate (1) the value and (2) one or more CSI report configurations 710 that are to be triggered by reception of an aperiodic CSI request including the value. In such examples, upon receiving an aperiodic CSI request at 810 that includes the value, the UE 804 transmits one or more CSI reports according to the one or more CSI report configurations 710 that are configured as associated with the value.

In some aspects, the configuration 700 (or other configuration signaling such as other RRC signaling) may indicate that the UE 804 is to identify one or more CSI reports for transmission in response to an aperiodic CSI request based on an ordering of indexes of the configuration 700, such as an ordering of indexes of associated CSI report configurations 704, an ordering of indexes of CSI report configurations 710, an ordering of indexes of CSI resource configurations 712, an ordering of indexes of CSI resources 714, or a combination thereof. The determination of the one or more CSI reports based on the ordering of indexes is described in more detail below.

At 808, the network entity 802 transmits, and the UE 804 receives, an aperiodic CSI request that triggers transmission of CSI reporting. For example, the aperiodic CSI request may be included in DCI (e.g., DCI 702). In some aspects, the network entity 802 transmits the aperiodic CSI request as part of a mobility operation. For example, the network entity 802 may transmit the aperiodic CSI request via a RAR of a RACH procedure associated with the mobility operation. The aperiodic CSI request of example 800 indicates fewer CSI reports than the plurality of CSI reports, as described in connection with the DCI 702 of FIG. 7.

At 810, the UE 804 transmits, and the network entity 802 receives, one or more CSI reports. In some aspects, another network entity may receive the one or more CSI reports. For example, a first network entity may trigger the one or more CSI reports via the aperiodic CSI request, and the UE 804 may transmit the one or more CSI reports to the second network entity. In some aspects, the UE 804 may identify the one or more CSI reports. For example, the UE 804 may identify one or more CSI report configurations 710, and may transmit the one or more CSI reports based on (1) performing CSI measurements on CSI resources 714 identified by CSI resource configurations 712 that are linked to the one or more CSI report configurations 710, and (2) generating CSI, in accordance with the CSI measurements, for reporting the one or more CSI reports.

In some aspects, the UE 804 transmits the one or more CSI reports according to an ordering of indexes of the configuration 700. For example, the UE 804 may transmit the one or more CSI reports according to an ordering of indexes of two or more associated CSI report configurations 704, if two or more associated CSI report configurations are defined in the configuration 700. In such examples, the UE 804 may transmit a CSI report defined by a lowest-indexed associated CSI report configuration 704 (e.g., associated with a lowest index, such as 0 if zero-indexing is used). As another example, the UE 804 may transmit the one or more CSI reports according to an ordering of indexes of two or more CSI report configurations 710. For example, if the configuration 700 includes only a single associated CSI report configuration 704 that is configured with multiple CSI report configurations 710, or if a lowest-indexed associated CSI report configuration 704 is configured with multiple CSI report configurations 710, the UE 804 may transmit the one or more CSI reports according to a lowest-indexed CSI report configuration 710 of the multiple CSI report configurations 710. In some aspects, a similar ordering and/or selection may be applied for a CSI resource configuration 712 or a CSI resource 714.

Thus, if there are multiple associated CSI report configurations 704 (e.g., multiple associated report configuration lists in CSI-AperiodicTriggerStateList), the UE 804 may select the CSI report configuration 710 corresponding to the lowest index of all associated radio resource management parameters associated with the first active downlink bandwidth part of the target cell. If the CSI request field (e.g., aperiodic CSI request at 808) is indicated in a RAR or uplink grant, the CSI request field in the RAR or uplink grant corresponds to a lowest codepoint of the trigger state (e.g., associated CSI report configuration 704). If the lowest codepoint of the trigger state has multiple CSI report configurations 710, the CSI report corresponds to the CSI report configuration 710 with the lowest index, also referred to as identifier (CSI-ReportConfigId).

In some aspects, the aperiodic CSI request may include multiple bits (e.g., N bits), but the configuration 700 may include more than 2N associated CSI report configurations 704. In this example, the aperiodic CSI request may include multiple bits, but not as many bits as a number of codepoints in a DCI field for a CSI request for a non-handover scenario. The UE 804 may transmit one or more CSI reports according to the multiple bits. For example, the 2N codepoints (e.g., potential values) of the CSI request field in the aperiodic CSI request may correspond to the lowest 2N codepoints of the DCI field for the CSI request for the non-handover scenario. In other words, the UE 804 may transmit a CSI report indicated by a value of the CSI request field, where the value is interpreted to apply to one of the lowest 2N indexes of the associated CSI report configurations 704 or CSI report configurations 710.

Some forms of CSI report indicate a CSI-RS resource index (CRI) or an SSB resource index (SSBRI) (e.g., in a parameter such as cri-RI-PMI-CQI, cri-RI-i1, cri-RI-i1-CQI, cri-RI-CQI, cri-RSRP, ssb-Index-RSRP, cri-RI-LI-PMI-CQI, or the like) used to generate the CSI report. Some aspects described herein provide for the one or more CSI reports transmitted by the UE 804 to omit the CRI or SSBRI (since the CRI or SSBRI may be determinable from the mapping or ordering of indexes described above). Additionally, or alternatively, the UE 804 may report the CRI or SSBRI as the one decided according to the mapping or ordering of indexes.

In some aspects, the network entity 802 may be a source network entity of a mobility operation, and may provide the one or more CSI reports to a target network entity of the mobility operation. In some aspects, the network entity 802 may be the target network entity.

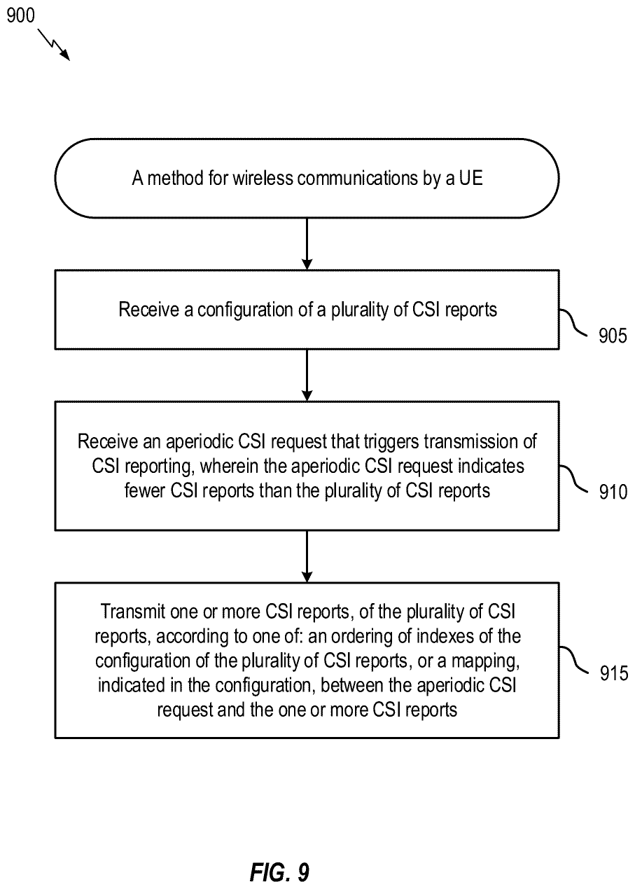

FIG. 9 shows a method 900 for wireless communications by an apparatus, such as UE 104 of FIG. 1 or UE 304 of FIG. 3.

Method 900 begins at block 905 with receiving a configuration of a plurality of CSI reports.

Method 900 then proceeds to block 910 with receiving an aperiodic CSI request that triggers transmission of CSI reporting, wherein the aperiodic CSI request indicates fewer CSI reports than the plurality of CSI reports.

Method 900 then proceeds to block 915 with transmitting one or more CSI reports, of the plurality of CSI reports, according to one of: an ordering of indexes of the configuration of the plurality of CSI reports, or a mapping, indicated in the configuration, between the aperiodic CSI request and the one or more CSI reports.

In some aspects, the plurality of CSI reports are associated with a plurality of associated CSI report configurations, and wherein block 915 includes transmitting a CSI report according to an associated CSI report configuration associated with a lowest index of indexes of the plurality of associated CSI report configurations.

In some aspects, the associated CSI report configuration is associated with a plurality of CSI report configurations, and wherein the CSI report is according to a CSI report configuration having a lowest CSI report configuration identifier of CSI report configuration identifiers of the plurality of CSI report configurations.

In some aspects, the CSI report is according to a CSI report configuration that is configured with a plurality of CSI resource configurations, and wherein the CSI report is associated with a CSI resource configuration, of the plurality of CSI resource configurations, having a lowest CSI resource configuration index of CSI resource configuration indexes of the plurality of CSI resource configurations.

In some aspects, the CSI report is according to a CSI report configuration that is configured with a plurality of CSI resources, and wherein the CSI report is associated with a CSI resource, of the plurality of CSI resources, having a lowest CSI resource index of CSI resource indexes of the plurality of CSI resources.

In some aspects, the aperiodic CSI request includes an indication to transmit a CSI report without indicating a CSI report configuration for the CSI report.

In some aspects, the indication is in a CSI request field of a random access response or an uplink grant.

In some aspects, the mapping indicates a set of indexes that indicate the one or more CSI reports, wherein to cause the UE to transmit the one or more CSI reports according to the mapping, the processing system is configured to cause the UE to transmit the one or more CSI reports in accordance with the set of indexes.

In some aspects, the aperiodic CSI request indicates the one or more CSI reports.

In some aspects, a field of the aperiodic CSI request is capable of indicating a quantity of CSI reports comprising fewer CSI reports than the plurality of CSI reports, and wherein the field indicates the one or more CSI reports from the quantity of CSI reports.

In some aspects, the quantity of CSI reports comprise CSI reports associated with lowest indexes of the plurality of CSI reports.

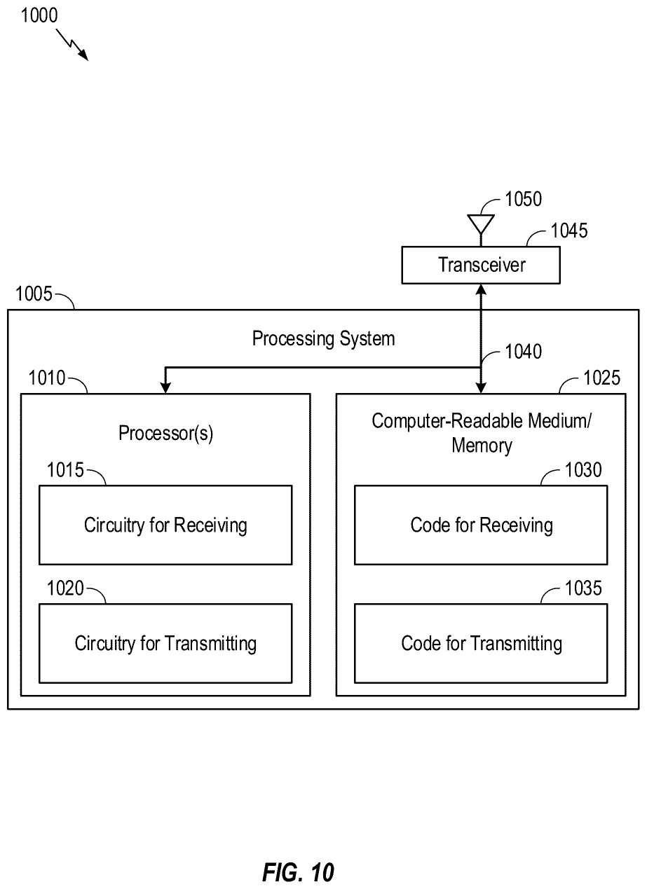

In some aspects, method 900, or any aspect related to it, may be performed by an apparatus, such as communications device 1000 of FIG. 10, which includes various components operable, configured, or adapted to perform the method 900. Communications device 1000 is described below in further detail.

Note that FIG. 9 is just one example of a method, and other methods including fewer, additional, or alternative operations are possible consistent with this disclosure.

### Example Communications Device

FIG. 10 depicts aspects of an example communications device 1000 configured for wireless communications. In some aspects, communications device 1000 is a user equipment, such as UE 104 described above with respect to FIG. 1 or UE 304 described with respect to FIG. 3.

The communications device 1000 includes a processing system 1005 coupled to a transceiver 1045 (e.g., a transmitter and/or a receiver). The transceiver 1045 is configured to transmit and receive signals for the communications device 1000 via an antenna 1050, such as the various signals as described herein. The processing system 1005 may be configured to perform processing functions for the communications device 1000, including processing signals received and/or to be transmitted by the communications device 1000.

The processing system 1005 includes one or more processors 1010 and a computer-readable medium/memory 1025. In various aspects, the one or more processors 1010 may be representative of the one or more processors 318 described with respect to FIG. 3. The one or more processors 1010 are coupled to a computer-readable medium/memory 1025 via a bus 1040. In some aspects, the computer-readable medium/memory 1025 may be representative of the one or more memories 320 described with respect to FIG. 3. The computer-readable medium/memory 1025 is a non-transitory computer-readable medium/memory. In certain aspects, the computer-readable medium/memory 1025 is configured to store instructions (e.g., computer-executable code), that when executed by the one or more processors 1010, cause the one or more processors 1010 to perform the method 900 described with respect to FIG. 9, or any aspect related to it, including any operations described in relation to FIG. 9. Note that reference to a processor performing a function of communications device 1000 may include one or more processors performing that function of communications device 1000, such as in a distributed fashion.

In the depicted example, computer-readable medium/memory 1025 stores code (e.g., executable instructions), including code for receiving 1030 and code for transmitting 1035. Processing of the code 1030 and 1035 may enable and cause the communications device 1000 to perform the method 900 described with respect to FIG. 9, or any aspect related to it. For instance, in some aspects, code for receiving 1030 includes code for receiving a configuration of a plurality of CSI reports. In some aspects, code for receiving 1030 includes code for receiving an aperiodic CSI request that triggers transmission of CSI reporting, wherein the aperiodic CSI request indicates fewer CSI reports than the plurality of CSI reports. In some aspects, code for transmitting 1035 includes code for transmitting the one or more CSI reports according to a rule that indicates a set of CSI reports, of the plurality of CSI reports, that are to be transmitted as the one or more CSI reports.

The one or more processors 1010 include circuitry configured to implement (e.g., execute) the code stored in the computer-readable medium/memory 1025, including circuitry for receiving 1015 and circuitry for transmitting 1020. Processing with circuitry 1015 and 1020 may enable and cause the communications device 1000 to perform the method 900 described with respect to FIG. 9, or any aspect related to it. For instance, in some aspects, circuitry for receiving 1015 includes circuitry for receiving a configuration of a plurality of CSI reports. In some aspects, circuitry for receiving 1015 includes circuitry for receiving an aperiodic CSI request that triggers transmission of CSI reporting, wherein the aperiodic CSI request indicates fewer CSI reports than the plurality of CSI reports. In some aspects, circuitry for transmitting 1020 includes circuitry for transmitting the one or more CSI reports according to a rule that indicates a set of CSI reports, of the plurality of CSI reports, that are to be transmitted as the one or more CSI reports.

More generally, means for communicating, transmitting, sending or outputting for transmission may include the one or more transceivers 324, one or more antenna 322 and/or processing system 316 of the UE 304 illustrated in FIG. 3, transceiver 1045 and/or antenna 1050 of the communications device 1000 in FIG. 10, and/or one or more processors 1010 of the communications device 1000 in FIG. 10. Means for communicating, receiving or obtaining may include the one or more transceivers 324, one or more antennas 322, and/or processing system 316 of the UE 304 illustrated in FIG. 3, transceiver 1045 and/or antenna 1050 of the communications device 1000 in FIG. 10, and/or one or more processors 1010 of the communications device 1000 in FIG. 10.

### EXAMPLE CLAUSES

Implementation examples are described in the following numbered clauses:

Clause 1: A method for wireless communications by a UE comprising: receive a configuration of a plurality of channel state information (CSI) reports; receive an aperiodic CSI request that triggers transmission of CSI reporting, wherein the aperiodic CSI request indicates fewer CSI reports than the plurality of CSI reports; and transmit one or more CSI reports, of the plurality of CSI reports, according to one of: an ordering of indexes of the configuration of the plurality of CSI reports, or a mapping, indicated in the configuration, between the aperiodic CSI request and the one or more CSI reports.

Clause 2: The method of Clause 1, wherein the plurality of CSI reports are associated with a plurality of associated CSI report configurations, and wherein transmitting the one or more CSI reports comprises transmitting a CSI report according to an associated CSI report configuration associated with a lowest index of indexes of the plurality of associated CSI report configurations.

Clause 3: The method of Clause 2, wherein the associated CSI report configuration is associated with a plurality of CSI report configurations, and wherein the CSI report is according to a CSI report configuration having a lowest CSI report configuration identifier of CSI report configuration identifiers of the plurality of CSI report configurations.

Clause 4: The method of any one of Clauses 1-3, wherein the aperiodic CSI request includes an indication to transmit a CSI report without indicating a CSI report configuration for the CSI report.

Clause 5: The method of Clause 4, wherein the indication is in a CSI request field of a random access response or an uplink grant.

Clause 6: The method of any one of Clauses 1-5, the mapping indicates a set of indexes that indicate the one or more CSI reports, wherein transmitting the one or more CSI reports comprises transmitting the one or more CSI reports in accordance with the set of indexes.

Clause 7: The method of any one of Clauses 1-6, wherein the aperiodic CSI request indicates the one or more CSI reports.

Clause 8: The method of Clause 7, wherein a field of the aperiodic CSI request is capable of indicating a quantity of CSI reports comprising fewer CSI reports than the plurality of CSI reports, and wherein the field indicates the one or more CSI reports from the quantity of CSI reports.

Clause 9: The method of Clause 8, wherein the quantity of CSI reports comprise CSI reports associated with lowest indexes of the plurality of CSI reports.

Clause 10: One or more apparatuses, comprising: one or more memories comprising executable instructions; and one or more processors configured to execute the executable instructions and cause the one or more apparatuses to perform a method in accordance with any one of Clauses 1-9.

Clause 11: One or more apparatuses configured for wireless communications, comprising: one or more memories; and one or more processors, coupled to the one or more memories, configured to cause the one or more apparatuses to perform a method in accordance with any one of Clauses 1-9.

Clause 12: One or more apparatuses configured for wireless communications, comprising: one or more memories; and one or more processors, coupled to the one or more memories, configured to perform a method in accordance with any one of Clauses 1-9.

Clause 13: One or more apparatuses, comprising means for performing a method in accordance with any one of Clauses 1-9.

Clause 14: One or more non-transitory computer-readable media comprising executable instructions that, when executed by one or more processors of one or more apparatuses, cause the one or more apparatuses to perform a method in accordance with any one of Clauses 1-9.

Clause 15: One or more computer program products embodied on one or more computer-readable storage media comprising code for performing a method in accordance with any one of Clauses 1-9.

Clause 16: One or more apparatuses configured for wireless communications, comprising: a processing system that includes one or more processors and one or more memories coupled with the one or more processors, the processing system configured to cause the one or more apparatuses to perform a method in accordance with any one of Clauses 1-9.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive a configuration of a plurality of channel state information (CSI) reports;
receive an aperiodic CSI request that triggers transmission of CSI reporting, wherein the aperiodic CSI request indicates fewer CSI reports than the plurality of CSI reports; and
transmit one or more CSI reports, of the plurality of CSI reports, according to one of:
an ordering of indexes of the configuration of the plurality of CSI reports, or
a mapping, indicated in the configuration, between the aperiodic CSI request and the one or more CSI reports.

2. The apparatus of claim 1, wherein the plurality of CSI reports are associated with a plurality of associated CSI report configurations, and wherein to cause the UE to transmit the one or more CSI reports according to the ordering, the processing system is configured to cause the UE to transmit a CSI report according to an associated CSI report configuration associated with a lowest index of indexes of the plurality of associated CSI report configurations.

3. The apparatus of claim 2, wherein the associated CSI report configuration is associated with a plurality of CSI report configurations, and wherein the CSI report is according to a CSI report configuration having a lowest CSI report configuration identifier of CSI report configuration identifiers of the plurality of CSI report configurations.

4. The apparatus of claim 1, wherein the aperiodic CSI request includes an indication to transmit a CSI report without indicating a CSI report configuration for the CSI report.

5. The apparatus of claim 4, wherein the indication is in a CSI request field of a random access response or an uplink grant.

6. The apparatus of claim 1, wherein the mapping indicates a set of indexes that indicate the one or more CSI reports, wherein to cause the UE to transmit the one or more CSI reports according to the mapping, the processing system is configured to cause the UE to transmit the one or more CSI reports in accordance with the set of indexes.

7. The apparatus of claim 1, wherein the aperiodic CSI request indicates the one or more CSI reports.

8. The apparatus of claim 7, wherein a field of the aperiodic CSI request is capable of indicating a quantity of CSI reports comprising fewer CSI reports than the plurality of CSI reports, and wherein the field indicates the one or more CSI reports from the quantity of CSI reports.

9. The apparatus of claim 8, wherein the quantity of CSI reports comprise CSI reports associated with lowest indexes of the plurality of CSI reports.

10. A method for wireless communications by a user equipment (UE) comprising:
receiving a configuration of a plurality of channel state information (CSI) reports;
receiving an aperiodic CSI request that triggers transmission of CSI reporting, wherein the aperiodic CSI request indicates fewer CSI reports than the plurality of CSI reports; and
transmitting one or more CSI reports, of the plurality of CSI reports, according to one of:
an ordering of indexes of the configuration of the plurality of CSI reports, or
a mapping, indicated in the configuration, between the aperiodic CSI request and the one or more CSI reports.

11. The method of claim 10, wherein the plurality of CSI reports are associated with a plurality of associated CSI report configurations, and wherein transmitting the one or more CSI reports according to the ordering comprises transmitting a CSI report according to an associated CSI report configuration associated with a lowest index of indexes of the plurality of associated CSI report configurations.

12. The method of claim 11, wherein the associated CSI report configuration is associated with a plurality of CSI report configurations, and wherein the CSI report is according to a CSI report configuration having a lowest CSI report configuration identifier of CSI report configuration identifiers of the plurality of CSI report configurations.

13. The method of claim 10, wherein the aperiodic CSI request includes an indication to transmit a CSI report without indicating a CSI report configuration for the CSI report.

14. The method of claim 13, wherein the indication is in a CSI request field of a random access response or an uplink grant.

15. The method of claim 10, wherein the mapping indicates a set of indexes that indicate the one or more CSI reports, wherein transmitting the one or more CSI reports according to the mapping comprises transmitting the one or more CSI reports in accordance with the set of indexes.

16. The method of claim 10, wherein the aperiodic CSI request indicates the one or more CSI reports.

17. The method of claim 16, wherein a field of the aperiodic CSI request is capable of indicating a quantity of CSI reports comprising fewer CSI reports than the plurality of CSI reports, and wherein the field indicates the one or more CSI reports from the quantity of CSI reports.

18. The method of claim 17, wherein the quantity of CSI reports comprise CSI reports associated with lowest indexes of the plurality of CSI reports.

19. One or more non-transitory computer-readable media comprising executable instructions that, when executed by one or more processors of an apparatus, cause the apparatus to perform operations comprising:
receiving a configuration of a plurality of channel state information (CSI) reports;
receiving an aperiodic CSI request that triggers transmission of CSI reporting, wherein the aperiodic CSI request indicates fewer CSI reports than the plurality of CSI reports; and
transmitting one or more CSI reports, of the plurality of CSI reports, according to one of:
an ordering of indexes of the configuration of the plurality of CSI reports, or
a mapping, indicated in the configuration, between the aperiodic CSI request and the one or more CSI reports.

20. The one or more non-transitory computer-readable media of claim 19, wherein a field of the aperiodic CSI request is capable of indicating a quantity of CSI reports comprising fewer CSI reports than the plurality of CSI reports, and wherein the field indicates the one or more CSI reports from the quantity of CSI reports.
